(19) United States
(12) Patent Application Publication
(10) Pub. No.: US 2015/0080014 A1
(43) Pub. Date: Mar. 19, 2015

(54) INDOOR LOCATION DETERMINATION OF ACCESS POINTS USING MOBILE DEVICE INDOOR LOCATION INFORMATION

(71) Applicants: Yaron Ben-Yosef, Rosh Haayin (IL); Avi Sharon, Modiin (IL)

(72) Inventors: Yaron Ben-Yosef, Rosh Haayin (IL); Avi Sharon, Modiin (IL)

(21) Appl. No.: 14/127,998

(22) PCT Filed: Sep. 13, 2013
(86) PCT No.: PCT/US13/59714

§ 371 Date: Dec. 20, 2013

(51) Int. Cl. H04W 4/04

(52) U.S. Cl. CPC H04W 4/04
USPC 455/456.1

(57) ABSTRACT

The present disclosure relates to computer-implemented methods and systems for determining the location of an access point. An example method may include receiving a plurality of data elements from a plurality of mobile devices. Each data element includes at least an indoor location of a respective mobile device. Each data element further includes a list of one or more radio frequency devices in the vicinity of the respective mobile device, and an indication of a signal strength between each of the one or more radio frequency devices in the vicinity of the respective mobile device and each respective mobile device. The method may also include analyzing the plurality of data elements to determine a location for a radio frequency device in the list of radio frequency devices. Furthermore, the method may include adding the determined location for the radio frequency device to a database.

### BACKGROUND

Recently, deriving and/or estimating indoor location information has grown increasingly important. One conventional method of estimating the indoor location of a particular mobile device may be to employ the known locations of access points or other devices near the mobile device. As access points are added to an indoor environment, the cost and time required to deploy such methods may become increasing deterrents to the utilization of such methods.

### BRIEF DESCRIPTION OF THE DRAWINGS

Reference will now be made to the accompanying figures and diagrams, which are not necessarily drawn to scale, and wherein:

FIG. 1 shows a block diagram of a system for indoor location determination, according to one or more example embodiments.

FIG. 2 shows a diagram of an indoor environment, according to one or more example embodiments.

FIG. 3 shows an example data flow for indoor location determination, according to one or more example embodiments.

FIG. 4 shows a flow diagram for location determination, according to one or more example embodiments.

### DETAILED DESCRIPTION

In the following description, numerous specific details are set forth. However, it should be understood that embodiments of the present disclosure may be practiced without these specific details. In other instances, well-known methods, structures, and techniques have not been shown in detail in order not to obscure an understanding of this description. References to “one embodiment.” “an embodiment.” “example embodiment,” “various embodiments.” and so forth indicate that the embodiment(s) of the present disclosure so described may include a particular feature, structure, or characteristic, but not every embodiment necessarily includes the particular feature, structure, or characteristic. Furthermore, repeated use of the phrase “in one embodiment” does not necessarily refer to the same embodiment, although it may.

As used herein, unless otherwise specified, the use of the ordinal adjectives “first,” “second,” “third,” etc., to describe a common object merely indicates that different instances of like objects are being referred to and are not intended to imply that the objects so described must be in a given sequence, either temporally, spatially, in ranking, or in any other manner.

As used herein, unless otherwise specified, the term “mobile device” refers, in general, to a wireless communication device, and more particularly to one or more of the following: a portable electronic device, a telephone (e.g., cellular phone, smart phone), a computer (e.g., laptop computer, tablet computer), a portable media player, a personal digital assistant (PDA), or any other electronic device having a networked capability.

As used herein, unless otherwise specified, the term “server” may refer to any computing device having a networked connectivity and configured to provide one or more dedicated services to clients, such as a mobile device. The services may include storage of data or any kind of data processing. One example of the server may include a web server hosting one or more web pages. Some examples of web pages may include social networking web pages. Another example of a server may be a cloud server that hosts web services for one or more computer devices.

As used herein, unless otherwise specified, the term “receiver” may refer to any device or component capable of receiving data, signals, information, etc. For example, a receiver may include an antenna or any other receiving device.

As used herein, unless otherwise specified, the term “transmitter” may refer to any device or component capable of transmitting data, signals, information, etc. For example, a transmitter may also include an antenna or any other transmission device.

The present disclosure relates to computer-implemented systems and methods for determining an indoor location of a radio frequency device. According to one or more embodiments of the disclosure, a method is provided. The method may include receiving, by a computing device including one or more processors, a plurality of data elements front a plurality of mobile devices. Each data element includes at least an indoor location of a respective mobile device. Each data element further includes a list of one or more radio frequency devices in the vicinity of the respective mobile device, and an indication of a signal strength between each of the one or more radio frequency devices in the vicinity of the respective mobile device and each respective mobile device. The method may also include analyzing, by the computing device, the plurality of data elements to determine a location for a radio frequency device in the list of radio frequency devices. Furthermore, the method may include adding, by the computing device, the determined location for the radio frequency device to a database.

According to one or more embodiments of the disclosure, a device is provided. The device may include at least one processor. Additionally, the device may also include at least one memory storing computer-executable instructions. When executed by the at least one processor, the instructions may cause the processor to receive a plurality of data elements from a plurality of mobile devices. Each data element includes at least an indoor location of a respective mobile device. Each data element further includes a list of one or more radio frequency devices in the vicinity of the respective mobile device, and an indication of a signal strength between each of the one or more radio frequency devices in the vicinity of the respective mobile device and each respective mobile device. The instructions may further cause the processor to analyze the plurality of data elements to determine a location for a radio frequency device in the list of radio frequency devices. Furthermore, the instructions may cause the processor to add the determined location for the radio frequency device to a database.

According to one or more embodiments of the disclosure, a non-transitory computer-readable medium is provided. The non-transitory computer-readable medium may have embodied thereon instructions executable by at least one processor. The instructions may cause the at least one processor to receive a plurality of data elements from a plurality of mobile devices. Each data element includes at least an indoor location of a respective mobile device. Each data element further includes a list of one or more radio frequency devices in the vicinity of the respective mobile device, and an indication of a signal strength between each of the one or more radio frequency devices in the vicinity of the respective mobile device and each respective mobile device. The instructions may further cause the processor to analyze the plurality of data elements to determine a location for a radio frequency device in the list of radio frequency devices. Furthermore, the instructions may cause the processor to add the determined location for the radio frequency device to a database.

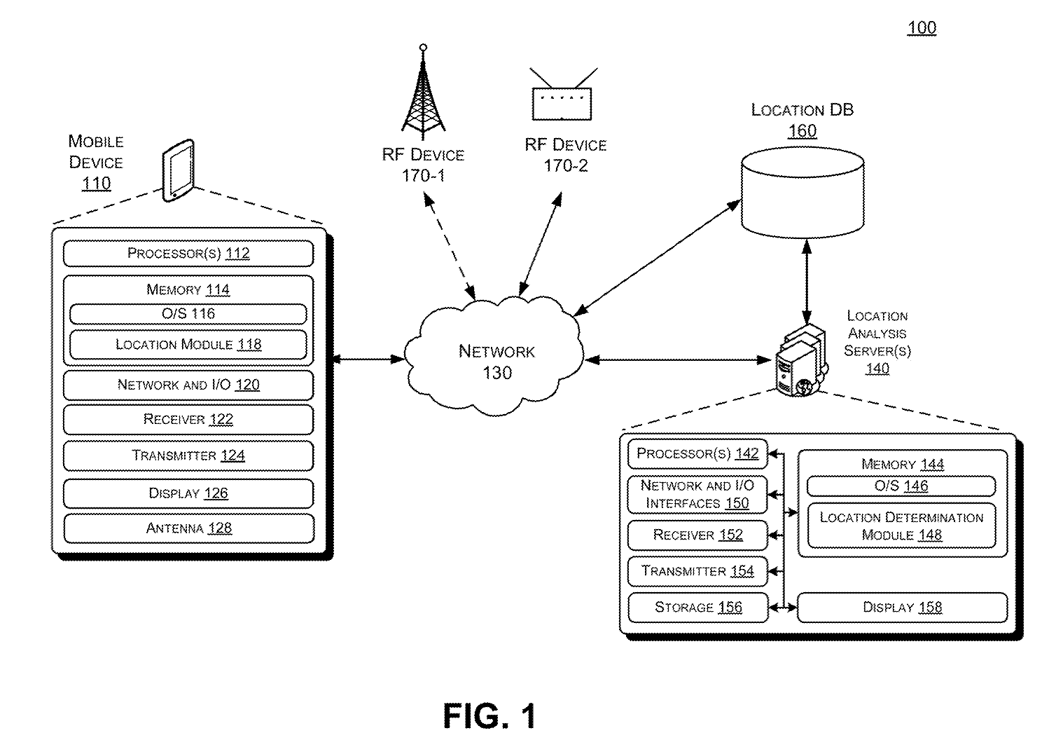

The above principles, as well as perhaps others, are now illustrated with reference to FIG. 1, which depicts a system 100 for determining an indoor location of a device. The system 100 may include a mobile device 110 having one or more processors 112, a memory 114 storing an operating system 116 and location module 118, network and input/output (I/O) interfaces 120, a receiver 122, a transmitter 124, a display 126, and an antenna 128, and in communication with each other.

The computer processors 112 may comprise one or more cores and may be configured to access and execute (at least in part) computer-readable instructions stored in the memory 114. The one or more computer processors 112 may include, without limitation: a central processing unit (CPU), a digital signal processor (DSP), a reduced instruction set computer (RISC), a complex instruction set computer (CISC), a microprocessor, a microcontroller, a field programmable gate array (FPGA), or any combination thereof. The mobile device 110 may also include a chipset (not shown) for controlling communications between the one or more processors 112 and one or more of the other components of the mobile device 110. In certain embodiments, the mobile device 110 may be based on an Intel® architecture or an ARM® architecture, and the processor(s) and chipset may be from a family of Intel® processors and chipsets, or any other family of processors and chipsets. The one or more processors 112 may also include one or more application-specific integrated circuits (ASICs) or application-specific standard products (ASSPs) for handling specific data processing functions or tasks.

The memory 114 may comprise one or more computer-readable storage media (CRSM). In some embodiments, the memory 114 may include non-transitory media such as random access memory (RAM), flash RAM, magnetic media, optical media, solid-state media, and so forth. The memory 114 may be volatile (in that information is retained while providing power) or non-volatile (in that information is retained without providing power). Additional embodiments may also be provided as a computer program product including a transitory machine-readable signal (in compressed or uncompressed form). Examples of machine-readable signals include, but are not limited to, signals carried by the Internet or other networks. For example, distribution of software via the Internet may include a transitory machine-readable signal. Additionally, the memory 114 may store an operating system 116 that includes a plurality of computer-executable instructions that may be implemented by the computer processor 112 to perform a variety of tasks to operate the interface(s) and any other hardware installed on the mobile device 110. The memory 114 may also store content that may be displayed by the mobile device 110 or transferred to other devices (e.g., headphones) to be displayed or played by the other devices. The memory 114 may also store content received from the other devices. The content from the other devices may be displayed, played, or used by the mobile device 110 to perform any necessary tasks or operations that may be implemented by the computer processor 112 or other components in the mobile device 110. The memory may also store a location module 118 that includes a plurality of computer-executable instructions that may be implemented by the computer processor 112 to perform a variety of tasks, as will be further explained below.

The network and I/O interfaces 120 may also comprise one or more communication interfaces or network interface devices to provide for the transfer of data between the mobile device 110 and another device (e.g., network server) via a network, such as network 130. The communication interfaces may include, but are not limited to: personal area networks (PANs), wired local area networks (LANs), wireless local area networks (WLANs), wireless wide area networks (WWANs), and so forth. The mobile device 110 may be coupled to the network via a wired connection. The wireless system interfaces may include the hardware and software to broadcast and receive messages according to a wireless networking standard, such as, for example, the Wi-Fi Direct Standard (see e.g. Wi-Fi Direct specification published in October 2010), a IEEE 802.11 wireless standard (see e.g. IEEE 802.11-2012, published Mar. 29, 2012; IEEE 802.1 lac, 802.1 lad, et al.). Bluetooth, a combination thereof, or any other wireless standard.

The wireless system (not shown) may include a receiver 122 and a transmitter 124 or a transceiver capable of operating in a broad range of operating frequencies governed by the IEEE 802.11 wireless standard. For example, a physical layer interface in the receiver 122 may include a radio frequency unit that may be configured to provide for reception of one or more radio frequency signals at one or more frequencies. The radio frequency unit may include an amplifier, a mixer, a local oscillator, and/or other components, and may be implemented as discrete electronic components, integrated circuits, software-defined radio, or a combination thereof, according to various configurations. The transmitter 124 may send one or more radio frequency signals to other radio frequency devices. The communication interfaces may utilize acoustic, radio frequency, optical, or other signals to exchange data between the mobile device 110 and another device such as an access point, a host computer, a server, a router, a reader device, and the like. The network may include, but is not limited to: the Internet, a private network, a virtual private network, a wireless wide area network, a local area network, a metropolitan area network, a telephone network, and so forth.

The display 126 may include, but is not limited to, a liquid crystal display, a light-emitting diode display, or an E-Ink™ display as made by E Ink Corp. of Cambridge, Mass. Other such displays are possible as well. The display may be used to show content to a user in the form of text, images, or video. In certain instances, the display may also operate as a touch screen display that may enable the user to initiate commands or operations by touching the screen using certain finger or hand gestures. In some embodiments, a mobile device 110 may not have a display 126.

The system 100 may also include one or more location analysis servers 140. The location analysis server(s) 140 may include one or more processors 142 to execute instructions stored in a memory 144. The memory 144 may include an operating system (O/S) 146, and a location determination module 148. The location analysis server(s) 140 may further include network and I/O interfaces 150, a receiver 152, a transmitter 154, storage 156, and a display 158.

The system 100 may also include one or more location database(s) 160. Location database(s) 160 may be implemented as a relational database or non-relational database. In one embodiment, location database(s) 160 store locations associated with various radio frequency devices. For example, location database(s) 160 may store one or more associations between a media access control (MAC) address of a radio frequency device, and a location for the MAC address. In one embodiment, other device identification techniques may be used. The location may be a stored as a set of coordinates, such as a latitude coordinate and a longitude coordinate.

The system 100 may also include one or more radio frequency devices 170-1 and 170-2. Although two radio frequency devices are shown in FIG. 1, the system 100 may include any number of radio frequency devices. Radio frequency devices 170 may include, for example, an antenna, such as a cellular antenna. Radio frequency devices 170 may also include an access point, such as a wireless access point operating in an operating frequency governed by the IEEE 802.11 wireless standard, or a radio frequency beacon (such as a real-time location system beacon). Radio frequency devices 170-1 and 170-2 may be connected to network 130. In the case of a radio frequency device such as a radio frequency beacon, such a device may not be connected to a network. References herein to access points are equally applicable to radio frequency beacons or other devices that may have associated location information.

The mobile device 110, the location analysis server(s) 140, the location database 160, and the radio frequency devices 170 may be in communication with each other through one or more networks 130.

In addition, the receivers 122, 152 and the transmitters 124, 154 may be configured to receive and transmit signals according to various communication interfaces. Such communication interfaces may include a wireless local area network (WLAN), Bluetooth, a radio, and/or any other wireless communication interfaces.

In operation, a user of mobile device 110 may determine the location of mobile device 110 using, for example, location module 118. One example method of determining the location of mobile device 110 includes the use of a global navigation satellite system, such as a global positioning system (GPS), GLONASS, Galileo, or another such system. However, GPS and other satellite navigation systems have limited or no applicability if a mobile device 110 is located in an indoor environment.

Accordingly, in an indoor environment, a location module 118 may use other methods of determining the location of mobile device 110. For example, location module 118 may use a positioning system based on the location of Wi-Fi access points. Such positioning systems determine the location of a mobile device 110 based on the known location of one or more Wi-Fi access points near, in the vicinity of, or within range of a transceiver of mobile device 110. More particularly, a mobile device 110 may communicate information about various nearby access points to a location database 160. Such information may include, for example, a MAC address of each nearby access point. Using the received information, the location database 160 can communicate an estimated location for mobile device 110 to the mobile device. Alternatively, the location database 160 can communicate the locations for the received MAC addresses, and location module 118 of mobile device 110 can determine an estimated location for mobile device 110.

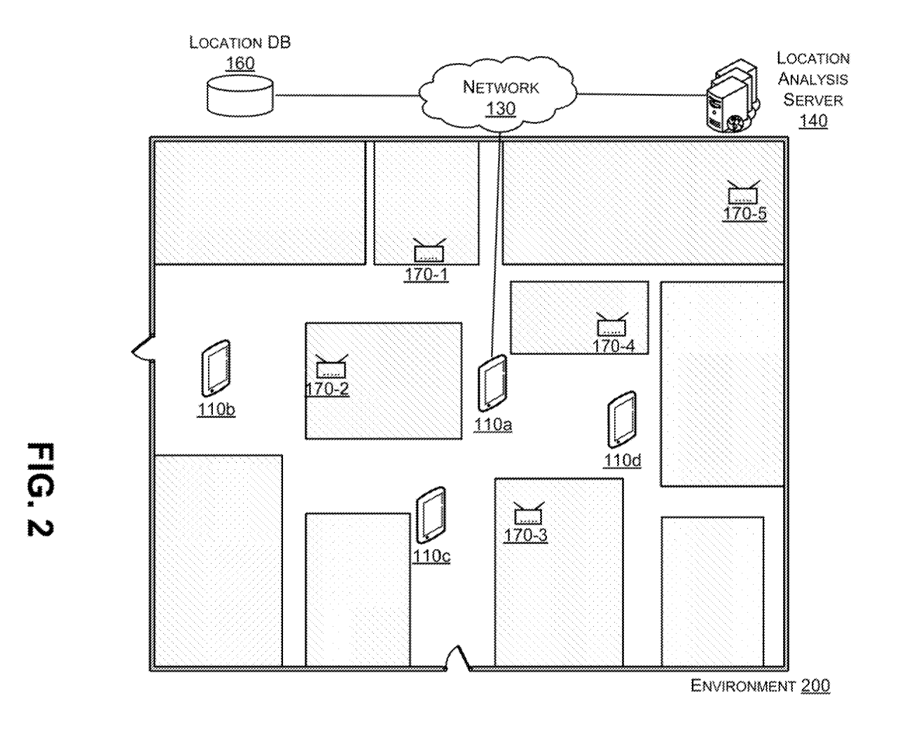

For example, consider the scenario illustrated in FIG. 2. Environment 200) of FIG. 2 represents, for example, an indoor shopping mall. The environment 200 may have multiple radio frequency devices within it, such as access points 170-1, 170-2, 170-3, 170-4, and 170-5. The environment 200 may also have multiple mobile devices 10a-110d within it. As one example, mobile device 110a may communicate information about the access points 170 through network 130 to a location database 160. For example, mobile device 110a may communicate the MAC addresses of each access point within range of the mobile device 110a to location database 160. Location database 160 may then respond to mobile device 110a with an approximate location of the mobile device. For example, in one embodiment, location database 160 may identify location information for access points 170-1, 170-2, and 170-3, and based on the location information for those access points, location database 160 may identify a location for mobile device 110a. As mentioned above, in one embodiment, location database 160 may identify location information for the access points 170-1, 170-2, and 170-3 and transmit the information to mobile device 110a; upon receiving the information, location module 118 of mobile device 110a may determine the location for mobile device 110a.

Such location databases 160 may be costly to develop. For example, for indoor environments, location databases 160 may be developed by creating a map of the indoor environment, and identifying the location of the various access points on the map. This development can require manual work and large numbers of man-hours. Alternatively, owners of an indoor environment can manually submit the location of access point(s) within the indoor environment to a party creating a location database 160.

However, in indoor environments, new access points are added frequently. These new access points typically do not have location information associated with them in a location database 160. Adding such location information may require a periodic manual process by a party offering a location database. For example, access points 170-4 and 170-5 in environment 200 may have been added after location database 160 was created, and thus may not have associated location information in location database 160. Adding such location information may improve the accuracy by which a mobile device 110 can receive its location from, for example, location database 160, or by which a mobile device 110 can determine its own location. Furthermore, adding such location information may allow another mobile device 110 to later use access points 170-4 and 170-5 to identify its location, if other access points are not nearby.

Various embodiments disclosed herein provide for determining a location for access points or other radio frequency devices in an indoor environment without location information, using information received from mobile devices. In one embodiment, a location analysis server may identify a location for an access point that has no location information in a location database (i.e. a new access point, or moved access point) by aggregating and analyzing various elements of data received from multiple mobile devices. Such a process may be known as crowdsourcing.

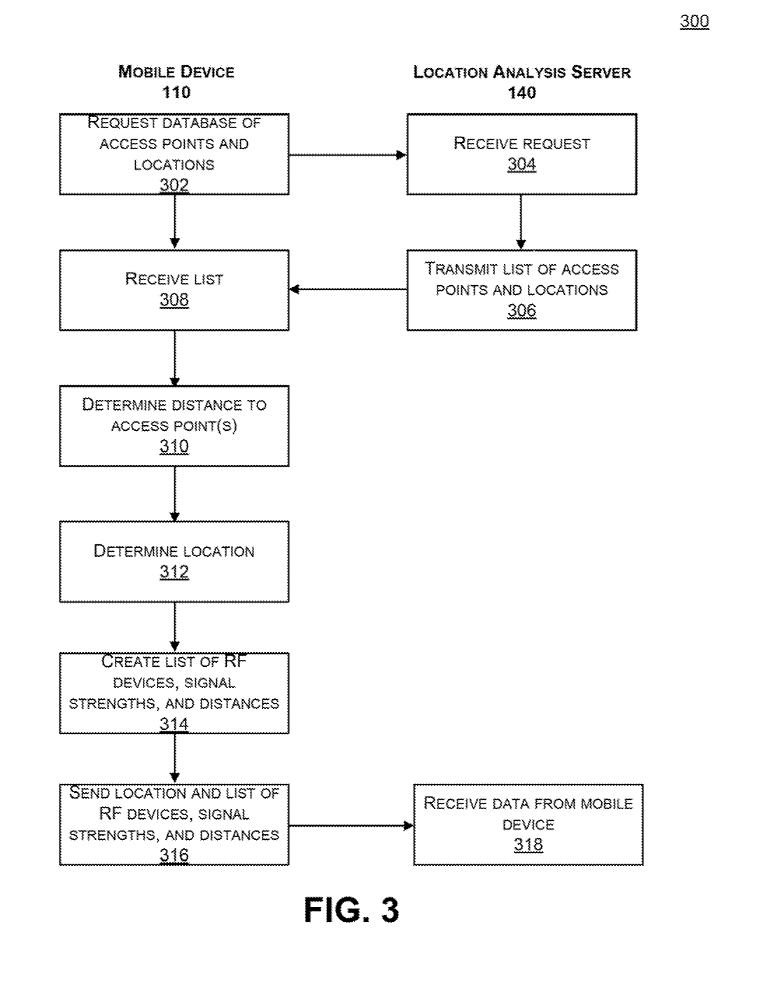

FIG. 3 is an example of a data flow 300 in accordance with one embodiment. The data flow 300 of FIG. 3 depicts an example interaction between a mobile device 110 and a location analysis server 140, and describes the various information exchanges between the two systems. Although two systems are depicted in data flow 300, such a data flow may be implemented using any number of additional intermediary systems, such as wireless routers, network hardware, switching stations, and the like. Additionally, the various operations of data flow 300 need not occur in the same order in which they are depicted in FIG. 3. Data flow 300 begins at block 302.

At block 302, mobile device 110 requests a database of access point locations from location analysis server 140. In one embodiment, the mobile device 110 may include a list of access points within range or vicinity of its transceiver to reduce the amount of data received from location analysis server 140. In one embodiment, the mobile device 110 may request the location of access points within its range, and/or the location of access points within a certain radius outside its range or a certain radius originating from mobile device 110. At block 304, location analysis server 140 receives the request from mobile device 110.

At block 306, location analysis server 140 transmits the list of locations for the access points to mobile device 110. In one embodiment, location analysis server 140 may work in conjunction with location database 160 to retrieve the requested information, and transmit the location information to mobile device 110. Alternatively, in one embodiment, mobile device 110 may transmit the request of block 302 directly or via another proxy to location database 160. At block 308, mobile device 110 receives the list of locations for the access points.

At block 310, mobile device 110 may determine a distance between mobile device 110 and one or more access points or other radio frequency devices. In one embodiment, the distance between mobile device 110 and an access point 160 may be determined based on a time of flight measurement. A time of flight measurement measures an accurate distance or range using the amount of time a radio signal travels or propagates through the air from the mobile device 110 to the access point 170. Mobile device 110 may determine the distance between mobile device 110 and each access point 170 within its range. Other location calculation algorithms for determining the distance between mobile device 110 and one or more access points may be used as well or in place of a time of flight measurement.

At block 312, using the access point locations and determined ranges, mobile device 110 may determine its location. In one embodiment, mobile device 110 may determine its location based on the locations of multiple access points. For example, three access point locations and ranges may be used to triangulate the position of mobile device 110. Mobile device 110 may also determine an accuracy range or confidence level for the determined location. For example, mobile device 110 may identify that the determined location is correct within a 5 meter radius. In one embodiment, mobile device 110 may assign a confidence level as a percentage; for example, mobile device 110 may identify a 95% confidence to its determined location. Using the time of flight measurement and triangulation methods may result in a highly accurate location determination for mobile device 110.

In one embodiment, mobile device 110 may also use a GPS signal to determine its location. For example, though GPS signals may have limited effectiveness indoors, if the mobile device 110 is located on the perimeter of an indoor environment such as a building (i.e. near an outside wall or structure), a GPS signal may be strong enough to be used to determine the location of the mobile device 110. This may be common, for example, if a user of mobile device 110 has just entered an indoor environment.

At block 314, mobile device 110 creates a list of radio frequency devices within its vicinity or range, and associated signal strengths between mobile device 110 and each radio frequency device in the list. Mobile device 110 may also include a range or distance between mobile device 110 and each radio frequency device in the list. The list of radio frequency devices within the mobile device's vicinity may include the MAC address of each radio frequency device. Signal strength may be measured by the received signal strength indication, which is a measurement of power present in a received radio signal. The signal strength may be measured in milliwatts (mW) or decibels per milliwatt (dBm), or any other appropriate measurement unit. In one embodiment, the list created at block 314 may include a scan of radio frequency devices compliant with the IEEE 802.11 standard, such as a Wi-Fi scan. In one embodiment, the list created at block 314 may also include information related to cellular towers associated with the mobile device.

At block 316, mobile device 110 may send its determined location, and the list of radio frequency devices and associated signal strengths and distances to location analysis server 140. At block 318, location analysis server 140 receives the data from mobile device 110, and may store the data in a memory.

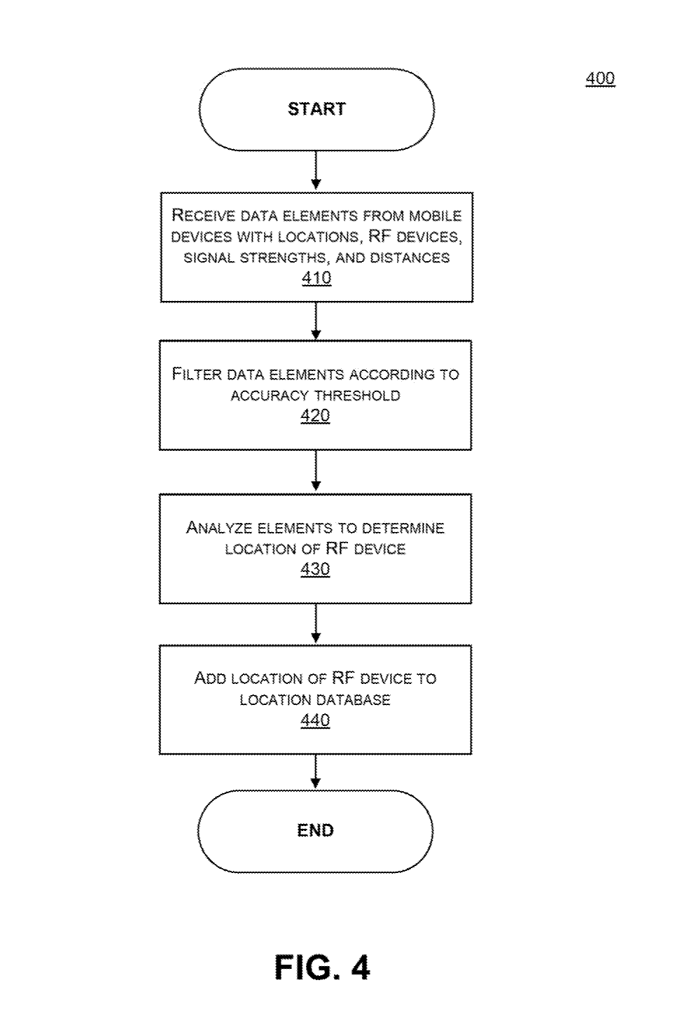

FIG. 4 illustrates a flow diagram of a method 400 for determining the location of an indoor radio frequency device according to one or more embodiments of the present disclosure. Method 400 may be implemented, in one embodiment, by location analysis server 140.

At block 410, location analysis server 140 may receive a plurality of data elements from a plurality of mobile devices 110. Each data element may include a location of the mobile device submitting or transmitting the data element. Additionally, each data element may include a list of radio frequency devices within a vicinity of the mobile device transmitting the data element. Furthermore, each data element may include an indication of signal strength between each of the radio frequency devices and the mobile device transmitting the data element. In one embodiment, a user of a mobile device 110 may be required to opt-in to the collection of data elements in accordance with block 410.

In one embodiment, each data element also includes an estimated accuracy of the location of the mobile device submitting the data element. In one embodiment, each data element includes a distance or range of distances between the mobile device and an access point or radio frequency device in the range of the mobile device. Such distances may also be associated with an estimated accuracy. Further, each data element may identify the source of the location (i.e., triangulation, GPS, etc.). In one embodiment, the source of the location may be based on a time of flight measurement. The list of radio frequency devices may also include MAC addresses or other identifiers for each radio frequency device.

At block 420, location analysis server 140 may filter the received data elements in accordance with various criteria. In one embodiment, location analysis server 140 may ignore or otherwise discard data elements in which the accuracy of the location of the mobile device submitting the data element is does not meet a certain threshold. For example, location analysis server 140 may ignore data elements with location accuracy above 25 meters or any other desired value. Similarly, location analysis server 140 may ignore data elements in which the accuracy of the location of the mobile device is below 90%. Such filtering may help ensure that a determined location for an access point is as accurate as possible.

At block 430, the plurality of received data elements may be analyzed to determine a location for a particular radio frequency device in the received list of radio frequency devices. For example, an access point having a specific MAC address may be included in a large number of the received data elements. Using the known locations of the mobile devices 110 submitting the data elements, and the signal strengths between the access point and the mobile devices, the location of the access point may be determined. The location may be identified in a latitude, longitude, and altitude (LLA) coordinate system, or any other coordinate system. In one embodiment, the analysis at block 430 is performed once location analysis server 140 receives a threshold number of data elements that include a particular MAC address. In one embodiment, the received data elements are analyzed to identify locations for MAC addresses without associated location information. Additionally, in one embodiment, the received data elements may be analyzed to improve the accuracy of existing locations for MAC addresses, or to update the location for MAC addresses corresponding to access points that have been moved recently.

At block 440, the determined location for the radio frequency device may be added to a database. For example, location analysis server 140 may associate the determined location with the radio frequency device's MAC address, and add the information to location database 160. In one embodiment, location server 140 may also transmit the determined location back to one or more mobile devices 110.

Although the operations of method 400 are described as being performed by location analysis server 140, a portion or all of the operations of method 400 may also be performed by mobile device 110. For example, mobile device 110 may store various elements of data with its determined location and list of radio frequency devices and associated nearby radio frequency devices. Upon storing a number of such data elements, mobile device 110 may filter the data elements as described with respect to block 420, analyze the data elements to determine a location for radio frequency devices common to the data elements as described with respect to block 430, and store the determined locations in a memory 114. In one embodiment, the determined locations may be transmitted to a location analysis server 140 or a location database 160.

Certain embodiments of the present disclosure are described above with reference to block and flow diagrams of systems and methods and/or computer program products according to example embodiments of the present disclosure. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the present disclosure.

These computer-executable program instructions may be laded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the present disclosure may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

While certain embodiments of the present disclosure have been described in connection with what is presently considered to be the most practical and various embodiments, it is to be understood that the present disclosure is not to be limited to the disclosed embodiments, but is intended to cover various modifications and equivalent arrangements included within the scope of the appended claims. Although specific terms are employed herein, they are used in a generic and descriptive sense only and not for purposes of limitation.

This written description uses examples to disclose certain embodiments of the present disclosure, including the best mode, and also to enable any person skilled in the art to practice certain embodiments of the present disclosure, including making and using any devices or systems and performing any incorporated methods. The patentable scope of certain embodiments of the present disclosure is defined in the claims, and may include outer examples that occur to those skilled in the art. Such other examples are intended to be within the scope of the claims if they have structural elements that do not differ from the literal language of the claims, or if they include equivalent structural elements with insubstantial differences from the literal language of the claims.

### EXAMPLES

Example 1 is a method for adding location information for a radio frequency device to a database comprising receiving, by a computing device comprising one or more processors, a plurality of data elements from a plurality of mobile devices, wherein each data element includes at least: (i) an indoor location of a respective mobile device, (ii) a list of one or more radio frequency devices in the vicinity of the respective mobile device, and (iii) an indication of a signal strength between each of the one or more radio frequency devices in the vicinity of the respective mobile device and each respective mobile device; analyzing, by the computing device, the plurality of data elements to determine a location for a radio frequency device in at least one of the list of radio frequency devices; and adding, by the computing device, the location for the radio frequency device to a database.

In Example 2, the subject matter of Example 1 can optionally include that each data element further includes an estimated accuracy of the indoor location of a respective mobile device.

In Example 3, the subject matter of Example 1 or Example 2 can optionally include that analyzing the plurality of data elements to determine at least one location for a radio frequency device in the list of radio frequency devices includes filtering data elements with an estimated accuracy meeting a given threshold.

In Example 4, the subject matter of Example 1 can optionally include that each data element further includes a distance between a respective mobile device and at least one radio frequency device in the vicinity of the respective mobile device.

In Example 5, the subject matter of Example 1 can optionally include that each data element includes an indication of a source of the indoor location of the respective mobile device.

In Example 6, the subject matter of Example 1 can optionally include that the list of one or more radio frequency devices in the vicinity of the respective mobile device includes a media access control (MAC) address for each radio frequency device on the list.

In Example 7, the subject matter of Example 1 can optionally include that the indoor location of the respective mobile device is based at least in part on a global positioning system location.

In Example 8 the subject matter of Example 1 can optionally include that the indoor location of the respective mobile device is based at least in part on a time of flight measurement.

In Example 9, the subject matter of Example 1 can optionally include that adding the location for the radio frequency device to a database includes associating the location for the radio frequency device with a media access control (MAC) address for the radio frequency device.

Example 10 is a system configured to perform any one of the methods of Examples 1-9.

Example 11 is a system for adding location information for a radio frequency device to a database comprising: at least one processor; and at least one memory storing computer-executable instructions, that when executed by the at least one processor, cause the at least one processor to: receive a plurality of data elements from a plurality of mobile devices, wherein each data element includes at least: (i) an indoor location of a respective mobile device, (ii) a list of one or more radio frequency devices in the vicinity of the respective mobile device, and (iii) an indication of a signal strength between each of the one or more radio frequency devices in the vicinity of the respective mobile device and each respective mobile device; analyze the plurality of data elements to determine a location for a radio frequency device in at least one of the list of radio frequency devices: and add the location for the radio frequency device to a database.

In Example 12, the subject matter of Example 11 can optionally include that each data element further includes an estimated accuracy of the indoor location of a respective mobile device.

In Example 13, the subject matter of Example 11 or Example 12 can optionally include that analyzing the plurality of data elements to determine at least one location for a radio frequency device in the list of radio frequency devices includes filtering data elements with an estimated accuracy meeting a given threshold.

In Example 14, the subject matter of Example 11 can optionally include that each data element further includes a distance between a respective mobile device and at least one radio frequency device in the vicinity of the respective mobile device.

In Example 15, the subject matter of Example 11 can optionally include that each data element includes an indication of a source of the indoor location of the respective mobile device.

In Example 16, the subject matter of Example 11 can optionally include that the list of one or more radio frequency devices in the vicinity of the respective mobile device includes a media access control (MAC) address for each radio frequency device on the list.

In Example 17, the subject matter of Example 11 can optionally include that the indoor location of the respective mobile device is based at least in part on a global positioning system location.

In Example 18, the subject matter of Example 1 can optionally include that the indoor location of the respective mobile device is based at least in part on a time of flight measurement.

In Example 19, the subject matter of Example 11 can optionally include that adding the location for the radio frequency device to a database includes associating the location for the radio frequency device with a media access control (MAC) address for the radio frequency device.

Example 20 is a non-transitory computer-readable medium comprising instructions, that when executed by at least one processor, cause the at least one processor to perform a method comprising receiving a plurality of data elements from a plurality of mobile devices, wherein each data element includes at least: (i) an indoor location of a respective mobile device, (ii) a list of one or more radio frequency devices in the vicinity of the respective mobile device, and (iii) an indication of a signal strength between each of the one or more radio frequency devices in the vicinity of the respective mobile device and each respective mobile device; analyzing the plurality of data elements to determine a location for a radio frequency device in the list of radio frequency devices: and adding the location for the radio frequency device to a database.

In Example 21, the subject matter of Example 20 can optionally include that each data element further includes an estimated accuracy of the indoor location of a respective mobile device.

In Example 22, the subject matter of Example 20 or Example 21 can optionally include that analyzing the plurality of data elements to determine at least one location for a radio frequency device in the list of radio frequency devices includes filtering data elements with an estimated accuracy meeting a given threshold.

In Example 23, the subject matter of Example 20 can optionally include that each data element further includes a distance between a respective mobile device and at least one radio frequency device in the vicinity of the respective mobile device.

In Example 24, the subject matter of Example 20 can optionally include that each data element includes an indication of a source of the indoor location of the respective mobile device.

In Example 25, the subject matter of Example 20 can optionally include that the list of one or more radio frequency devices in the vicinity of the respective mobile device includes a media access control (MAC) address for each radio frequency device on the list.

In Example 26, the subject matter of Example 20 can optionally include that the indoor location of the respective mobile device is based at least in part on a global positioning system location.

In Example 27 the subject matter of Example 20 can optionally include that the indoor location of the respective mobile device is based at least in part on a time of flight measurement.

In Example 28, the subject matter of Example 20 can optionally include that adding the location for the radio frequency device to a database includes associating the location for the radio frequency device with a media access control (MAC) address for the radio frequency device.

Example 29 is an apparatus for adding location information for a radio frequency device to a database comprising means for receiving a plurality of data elements from a plurality of mobile devices, wherein each data element includes at least: (i) an indoor location of a respective mobile device, (ii) a list of one or more radio frequency devices in the vicinity of the respective mobile device, and (iii) an indication of a signal strength between each of the one or more radio frequency devices in the vicinity of the respective mobile device and each respective mobile device; means for analyzing, by the computing device, the plurality of data elements to determine a location for a radio frequency device in at least one of the list of radio frequency devices; and means for adding, by the computing device, the location for the radio frequency device to a database.

In Example 30, the subject matter of Example 29 can optionally include that each data element further includes an estimated accuracy of the indoor location of a respective mobile device.

In Example 31, the subject matter of Example 29 or Example 30 can optionally include that analyzing the plurality of data elements to determine at least one location for a radio frequency device in the list of radio frequency devices includes filtering data elements with an estimated accuracy meeting a given threshold.

In Example 32, the subject matter of Example 29 can optionally include that each data element further includes a distance between a respective mobile device and at least one radio frequency device in the vicinity of the respective mobile device.

In Example 33, the subject matter of Example 29 can optionally include that each data element includes an indication of a source of the indoor location of the respective mobile device.

In Example 34, the subject matter of Example 29 can optionally include that the list of one or more radio frequency devices in the vicinity of the respective mobile device includes a media access control (MAC) address for each radio frequency device on the list.

In Example 35, the subject matter of Example 29 can optionally include that the indoor location of the respective mobile device is based at least in part on a global positioning system location.

In Example 36 the subject matter of Example 29 can optionally include that the indoor location of the respective mobile device is based at least in part on a time of flight measurement.

In Example 37, the subject matter of Example 29 can optionally include that adding the location for the radio frequency device to a database includes associating the location for the radio frequency device with a media access control (MAC) address for the radio frequency device.

Example 38 is a mobile device for contributing location information for radio frequency devices comprising at least one processor and memory: at least one location module configured to determine a location of the mobile device; an antenna in communication with a transceiver and a transceiver, configured to: identify one or more radio frequency devices in the vicinity of the mobile device and an associated signal strength between the mobile device and each radio frequency device in the vicinity of the mobile device; and transmit, to a server, the determined location and a data element comprising the identified radio frequency devices and associated signal strengths.

In Example 39, the subject matter of Example 38 can optionally include that the location module is further configured to identify an estimated accuracy of the location of the mobile device, and wherein the data element further comprises the estimated accuracy of the location of the mobile device.

In Example 40, the subject matter of Example 38 can optionally include that the transceiver is further configured to determine a distance between the mobile device and at least one radio frequency device in the vicinity of the mobile device, and wherein the data element further comprises the distance between the mobile device and the at least one radio frequency device in the vicinity of the mobile device.

In Example 41, the subject matter of Example 38 can optionally include that the data element further comprises an indication of a source of the indoor location of the respective mobile device.

In Example 42, the subject matter of Example 38 can optionally include that the data element further comprises a media access control (MAC) address for each identified radio frequency device.

In Example 43, the subject matter of Example 38 can optionally include that the location module is a global positioning system location module.

In Example 44, the subject matter of Example 38 can optionally include that the location module determines the location of the mobile device based at least in part on a time of flight measurement.

Example 45 is a method for contributing location information for radio frequency devices comprising determining, by a mobile device comprising at least one processor, a location of the mobile device; identifying, by the mobile device, one or more radio frequency devices in the vicinity of the mobile device and an associated signal strength between the mobile device and each radio frequency device in the vicinity of the mobile device; and transmitting, by the mobile device, the determined location and a data element comprising the identified radio frequency devices and associated signal strengths.

In Example 46, the subject matter of Example 45 can optionally include identifying, by the mobile device, an estimated accuracy of the location of the mobile device, and wherein the data element further comprises the estimated accuracy of the location of the mobile device.

In Example 47, the subject matter of Example 45 can optionally include determining, by the mobile device, a distance between the mobile device and at least one radio frequency device in the vicinity of the mobile device, and wherein the data element further comprises the distance between the mobile device and the at least one radio frequency device in the vicinity of the mobile device.

In Example 48, the subject matter of Example 45 can optionally include that the data element further comprises an indication of a source of the indoor location of the respective mobile device.

In Example 49, the subject matter of Example 45 can optionally include that the data element further comprises a media access control (MAC) address for each identified radio frequency device.

In Example 50, the subject matter of Example 45 can optionally include that determining the location of the mobile device is based at least in part on a time of flight measurement.

Example 51 is a system configured to perform any one of the methods of claims 45-50.

Example 52 is a non-transitory computer-readable medium comprising instructions, that when executed by at least one processor in a mobile device, cause the at least one processor to perform a method comprising determining a location of the mobile device; identifying one or more radio frequency devices in the vicinity of the mobile device and an associated signal strength between the mobile device and each radio frequency device in the vicinity of the mobile device; and transmitting the determined location and a data element comprising the identified radio frequency devices and associated signal strengths.

In Example 53, the subject matter of Example 52 can optionally include identifying an estimated accuracy of the location of the mobile device, and wherein the data element further comprises the estimated accuracy of the location of the mobile device.

In Example 54, the subject matter of Example 52 can optionally include determining a distance between the mobile device and at least one radio frequency device in the vicinity of the mobile device, and wherein the data element further comprises the distance between the mobile device and the at least one radio frequency device in the vicinity of the mobile device.

In Example 55, the subject matter of Example 52 can optionally include that the data element further comprises an indication of a source of the indoor location of the respective mobile device.

In Example 56, the subject matter of Example 52 can optionally include that the data element further comprises a media access control (MAC) address for each identified radio frequency device.

In Example 57, the subject matter of Example 52 can optionally include that determining the location of the mobile device is based at least in part on a time of flight measurement.

Example 58 is an apparatus for contributing location information for radio frequency devices, comprising means for determining a location of the mobile device; means for identifying one or more radio frequency devices in the vicinity of the mobile device and an associated signal strength between the mobile device and each radio frequency device in the vicinity of the mobile device; and means for transmitting the determined location and a data element comprising the identified radio frequency devices and associated signal strengths.

In Example 59, the subject matter of Example 58 can optionally include means for identifying an estimated accuracy of the location of the mobile device, and wherein the data element further comprises the estimated accuracy of the location of the mobile device.

In Example 60, the subject matter of Example 58 can optionally include means for determining a distance between the mobile device and at least one radio frequency device in the vicinity of the mobile device, and wherein the data element further comprises the distance between the mobile device and the at least one radio frequency device in the vicinity of the mobile device.

In Example 61, the subject matter of Example 58 can optionally include that the data element further comprises an indication of a source of the indoor location of the respective mobile device.

In Example 62, the subject matter of Example 58 can optionally include that the data element further comprises a media access control (MAC) address for each identified radio frequency device.

In Example 63, the subject matter of Example 58 can optionally include that determining the location of the mobile device is based at least in part on a time of flight measurement.

What is claimed is:

1. A method, comprising:
receiving, by a computing device comprising one or more processors, a plurality of data elements from a plurality of mobile devices, wherein each data element includes at least: (i) an indoor location of a respective mobile device, (ii) a list of one or more radio frequency devices in the vicinity of the respective mobile device, and (iii) an indication of a signal strength between each of the one or more radio frequency devices in the vicinity of the respective mobile device and each respective mobile device;
analyzing, by the computing device, the plurality of data elements to determine a location for a radio frequency device in at least one of the list of radio frequency devices; and
adding, by the computing device, the location for the radio frequency device to a database.

2. The method of claim 1, wherein each data element further includes an estimated accuracy of the indoor location of a respective mobile device.

3. The method of claim 2, wherein analyzing the plurality of data elements to determine at least one location for a radio frequency device in the list of radio frequency devices includes filtering data elements with an estimated accuracy meeting a given threshold.

4. The method of claim 1, wherein each data element further includes a distance between a respective mobile device and at least one radio frequency device in the vicinity of the respective mobile device.

5. The method of claim 1, wherein each data element includes an indication of a source of the indoor location of the respective mobile device.

6. The method of claim 1, wherein the list of one or more radio frequency devices in the vicinity of the respective mobile device includes a media access control (MAC) address for each radio frequency device on the list.

7. The method of claim 1, wherein the indoor location of the respective mobile device is based at least in part on a global positioning system location.

8. The method of claim 1, wherein the indoor location of the respective mobile device is based at least in part on a time of flight measurement.

9. The method of claim 1, wherein adding the location for the radio frequency device to a database includes associating the location for the radio frequency device with a media access control (MAC) address for the radio frequency device.

10. A system, comprising:
at least one processor; and
at least one memory storing computer-executable instructions that, when executed by the at least one processor, cause the at least one processor to:
receive a plurality of data elements from a plurality of mobile devices, wherein each data element includes at least: (i) an indoor location of a respective mobile device, (ii) a list of one or more radio frequency devices in the vicinity of the respective mobile device, and (iii) an indication of a signal strength between each of the one or more radio frequency devices in the vicinity of the respective mobile device and each respective mobile device;
analyze the plurality of data elements to determine a location for a radio frequency device in at least one of the list of radio frequency devices; and
add the location for the radio frequency device to a database.

11. The system of claim 10, wherein each data element further includes an estimated accuracy of the indoor location of a respective mobile device.

12. The system of claim 11, wherein analyzing the plurality of data elements to determine at least one location for a radio frequency device in the list of radio frequency devices includes filtering data elements with an estimated accuracy meeting a given threshold.

13. The system of claim 10, wherein each data element further includes a distance between a respective mobile device and at least one radio frequency device in the vicinity of the respective mobile device.

14. The system of claim 10, wherein each data element includes an indication of a source of the indoor location of the respective mobile device.

15. The system of claim 10, wherein the list of one or more radio frequency devices in the vicinity of the respective mobile device includes a media access control (MAC) address for each radio frequency device on the list.

16. The system of claim 10, wherein the indoor location of the respective mobile device is based at least in part on a global positioning system location.

17. The system of claim 10, wherein the indoor location of the respective mobile device is based at least in part on a time of flight measurement.

18. The system of claim 10, wherein adding the location for the radio frequency device to a database includes associating the location for the radio frequency device with a media access control (MAC) address for the radio frequency device.

19. A non-transitory computer-readable medium comprising instructions, that when executed by at least one processor, cause the at least one processor to:
receive a plurality of data elements from a plurality of mobile devices, wherein each data element includes at least: (i) an indoor location of a respective mobile device, (ii) a list of one or more radio frequency devices in the vicinity of the respective mobile device, and (iii) an indication of a signal strength between each of the one or more radio frequency devices in the vicinity of the respective mobile device and each respective mobile device;
analyze the plurality of data elements to determine a location for a radio frequency device in the list of radio frequency devices; and
add the location for the radio frequency device to a database.

20. A mobile device, comprising:
at least one processor and memory;
at least one location module configured to determine a location of the mobile device;
an antenna in communication with a transceiver; and
a transceiver, configured to:
identify one or more radio frequency devices in the vicinity of the mobile device and an associated signal strength between the mobile device and each radio frequency device in the vicinity of the mobile device; and
transmit, to a server, the determined location and a data element comprising the identified radio frequency devices and associated signal strengths.
